(19) United States
(12) Patent Application Publication
(10) Pub. No.: US 2026/0177089 A1
(43) Pub. Date: Jun. 25, 2026

(54) CONNECTING AND FIXING DEVICE FOR CART FRAME OF PULLING CART AND FLEXIBLE COMPARTMENT AND PULLING CART

(71) Applicant: Xiamen Roadzup Outdoor Products Co., Ltd., Xiamen City (CN)

(72) Inventor: Changjiu Huang, Xiamen City (CN)

(21) Appl. No.: 19/332,378

(22) Filed: Sep. 18, 2025

(30) Foreign Application Priority Data
Dec. 20, 2024 (CN) 202411885228.3

(51) Int. Cl. F16B 2/06; B62B 3/00; B62B 3/02

(52) U.S. Cl. CPC F16B 2/065; B62B 3/007; B62B 3/025; B62B 2205/06

(57) ABSTRACT

A connecting and fixing device for a cart frame of a pulling cart and a flexible compartment includes an upper connecting seat, an edge portion, a pressing block, and a fixing structure. The cart frame includes the upper connecting seat. The flexible compartment has the edge portion, and the edge portion has a thickness difference structure and has a thicker portion and an abutting portion. The fixing structure enables the pressing block and the upper connecting seat to be fixedly connected together, so that the edge portion is clamped by the pressing block and the upper connecting seat. A mating space is formed between the pressing block and the upper connecting seat. The thicker portion of the edge portion is located within the mating space, and the abutting portion is configured to abut the fixing structure or a limiting portion of the mating space facing outward.

### RELATED APPLICATIONS

This application claims priority to Chinese patent application number 202411885228.3, filed on Dec. 20, 2024. Chinese patent application number 202411885228.3 is incorporated herein by reference.

### FIELD OF THE DISCLOSURE

The present disclosure relates to a pulling cart, and in particular to a connection and fixing device for a cart frame and a flexible compartment and a pulling cart.

### BACKGROUND OF THE DISCLOSURE

Regarding a connection and fixing device for a frame and a flexible compartment of an existing pulling cart, please refer to FIGS. 1 and 2. The connection and fixing device is typically achieved by punching a large hole A1 into an edge portion of the flexible compartment, installing an annular eyelet buckle A2 or sewing a reinforced block with a hole, subsequently using a screw A3 to pass from bottom to top through an upper connecting seat A4 and the eyelet buckle A2, and finally locking the screw A3 with a nut A5 to achieve fixation. This fixing device is relatively complex, has a relatively high production cost, and because the installation of the eyelet buckle A2 or the reinforced block requires the flexible compartment to have a large hole punched into the flexible compartment, the connection strength of the flexible compartment is weakened.

### BRIEF SUMMARY OF THE DISCLOSURE

The technical problem to be solved by the present disclosure is to provide a connecting and fixing device for a cart frame of a pulling cart and a flexible compartment and a pulling cart, which overcomes the shortcomings existing in the background.

In order to solve the above technical problems, the present disclosure provides a connecting and fixing device for a cart frame of a pulling cart and a flexible compartment, and the connecting and fixing device comprises an upper connecting seat, an edge portion, a pressing block, and a fixing structure. The cart frame comprises the upper connecting seat. The flexible compartment has the edge portion, and the edge portion corresponds to the upper connecting seat and is disposed on the upper connecting seat. The edge portion has a thicker portion and an abutting portion facing inward and formed by the thicker portion. The pressing block comprises an upper through hole, and the pressing block is disposed on the edge portion. The fixing structure comprises a fixing member, and the fixing member passes through the upper through hole of the pressing block and the edge portion to be connected to the upper connecting seat. The fixing structure enables the pressing block and the upper connecting seat to be fixedly connected together, so that the edge portion is clamped by the pressing block and the upper connecting seat. A mating space is formed between the pressing block and the upper connecting seat, and the thicker portion of the edge portion is located within the mating space. The abutting portion is configured to abut the fixing structure or a limiting portion of the mating space facing outward.

A top surface of the upper connecting seat is recessed with a lower groove, and the lower groove has a first groove wall facing outward. At least a part of the thicker portion is located within the lower groove, and the limiting portion comprises the first groove wall. The abutting portion of the edge portion is configured to abut the limiting portion.

The lower groove extends to an outer side surface of the upper connecting seat, and an outer side of the pressing block extends downward to form an outer wrapping wall. The outer wrapping wall is located outside the upper connecting seat and at least encloses the lower groove.

A bottom surface of the pressing block is recessed with an upper groove, and the upper groove has a second groove wall facing outward. At least a part of the thicker portion is located within the upper groove, and the limiting portion comprises the second groove wall. The abutting portion of the edge portion is configured to abut the limiting portion.

A top surface of the upper connecting seat is recessed with a lower groove, and the lower groove has a first groove wall facing outward. A bottom surface of the pressing block is recessed with an upper groove, and the upper groove has a second groove wall facing outward. The thicker portion is located within the upper groove and the lower groove, and the limiting portion comprises at least one of the first groove wall or the second groove wall. The abutting portion of the edge portion is configured to abut the limiting portion.

The upper connecting seat comprises a lower connecting hole, and the fixing member passes through the upper through hole and the edge portion and is fixedly connected to the lower connecting hole. A top surface of the upper connecting seat is recessed with a lower groove, and the lower groove extends to the lower connecting hole. At least a part of the thicker portion is located within the lower groove, and the abutting portion of the edge portion is configured to abut the fixing member.

A bottom surface of the pressing block is recessed with an upper groove, and the upper groove extends to the upper through hole. At least a part of the thicker portion is located within the upper groove, and the abutting portion of the edge portion is configured to abut the fixing member.

The thicker portion comprises an encasing edge connected to a peripheral edge of the flexible compartment, and the encasing edge has at least one layer fixedly overlapping a surface of the edge portion. An inward-facing side of the at least one layer defines the abutting portion.

At least one fixing nail is provided to fixedly connect the edge portion and the at least one layer, and the mating space comprises a third groove that cooperates with a distal end of the at least one fixing nail. The distal end of the at least one fixing nail is located within the third groove, and the at least one layer of the encasing edge is two layers respectively fixedly overlapping a top surface and a bottom surface of the edge portion.

The fixing member is located outside the mating space.

The upper through hole is a stepped hole, and a top of the upper through hole is larger than a bottom of the upper through hole. A pressing lid is provided to cover the upper through hole from top to bottom.

The fixing member is a screw, and the screw passes through the upper through hole of the pressing block and the edge portion from top to bottom and is screwed into the upper connecting seat.

The present disclosure provides a pulling cart, and the pulling cart comprises the connecting and fixing device for the cart frame of the pulling cart and the flexible compartment.

Compared with the existing techniques, the technical solution has the following advantages.

The edge portion is fixedly connected to the cart frame and the flexible compartment through “the pressing block and the upper connecting seat clamping the edge portion” and “the abutting portion of the thicker portion abutting the limiting portion of the mating space or the fixing structure” to achieve dual fixation through “clamping” and “abutting.” The edge portion is clamped to ensure there is no space for the thicker portion to squeeze into at a clamping junction, thereby guaranteeing that the “abutting portion always abuts the limiting portion”, resulting in secure fixation. There is no need to create large holes or provide eyelet buckles on the edge portion, which enhances strength of the flexible compartment. A connection structure bears force evenly, has an aesthetically pleasing appearance, reduces the sewing workload in production, improves production efficiency, saves production costs, and generates economic benefits.

### BRIEF DESCRIPTION OF THE DRAWINGS

The present disclosure is further described below in conjunction with the accompanying drawings and specific embodiments.

FIG. 1 is a perspective view of a fixing device in background technology.

FIG. 2 is an exploded perspective view of the fixing device in the background technology.

FIG. 3 is a perspective view of a pulling cart in Embodiment 1.

FIG. 4 is a partially exploded perspective view of the pulling cart in Embodiment 1.

FIG. 5 is a perspective view of a cart frame of the pulling cart in Embodiment 1.

FIG. 6 is a partially exploded perspective view of the cart frame of the pulling cart in Embodiment 1.

FIG. 7 is a perspective view of a flexible compartment of the pulling cart in Embodiment 1.

FIG. 8 is an exploded perspective view of a connecting and fixing device in Embodiment 1.

FIG. 9 is a cross-sectional view of the connecting and fixing device in Embodiment 1.

FIG. 10 is an exploded perspective view of a connecting and fixing device in Embodiment 2.

FIG. 11 is a cross-sectional view of the connecting and fixing device in Embodiment 2.

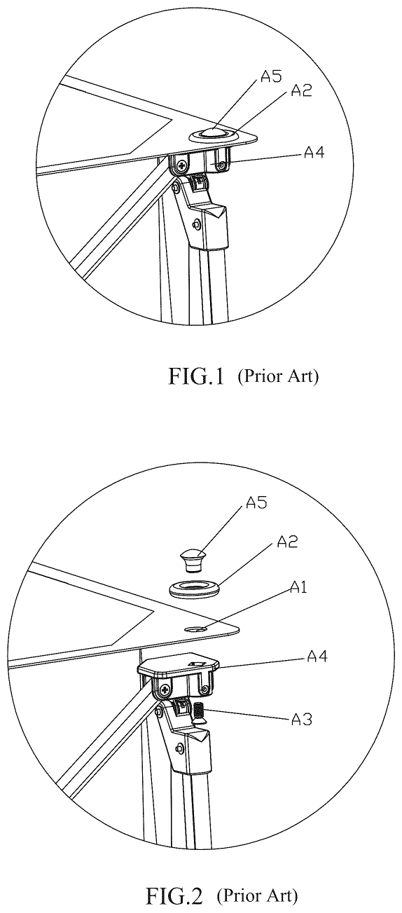

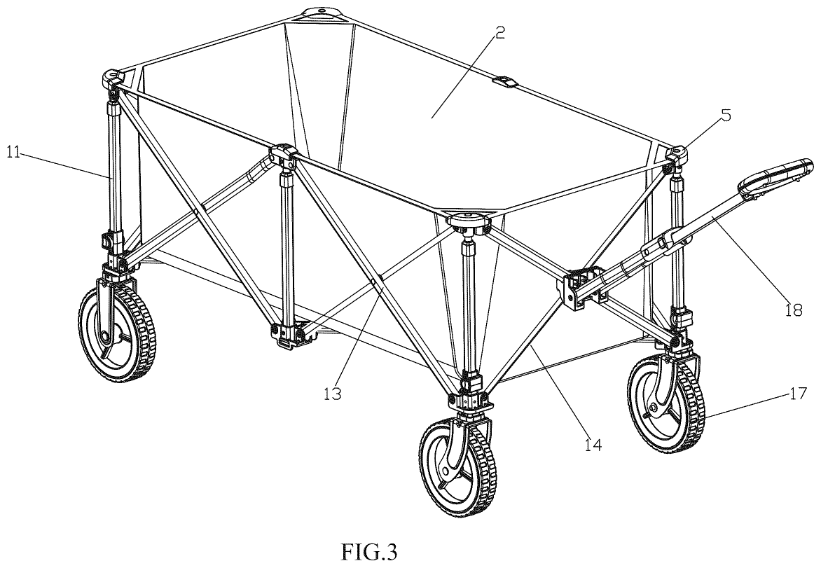

### REFERENCE NUMERALS

Cart frame 1, column 11, lower connecting seat 12, first scissor mechanism 13, second scissor mechanism 14, base 15, base rod 16, roller 17, and hand pull portion 18.
Flexible compartment 2, bottom wall 21, peripheral wall 22, and peripheral edge 23.
Upper connecting seat 3, lower groove 31, first groove wall 32, and lower connecting hole 33.
Edge portion 4, abutting portion 41, and encasing edge 42.
Pressing block 5, upper groove 51, second groove wall 52, outer wrapping wall 53, upper through hole 54, and pressing lid 55.
Fixing structure 6, and fixing member 61;
Mating space 7.

### DETAILED DESCRIPTION OF THE EMBODIMENTS

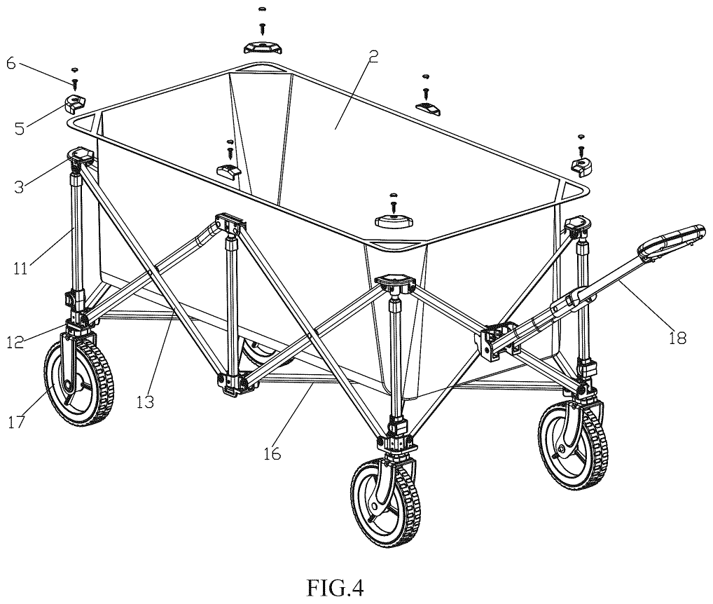

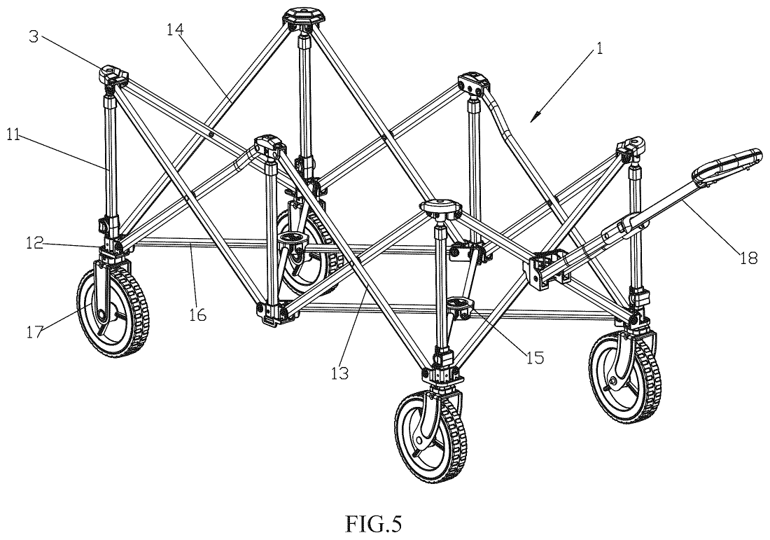

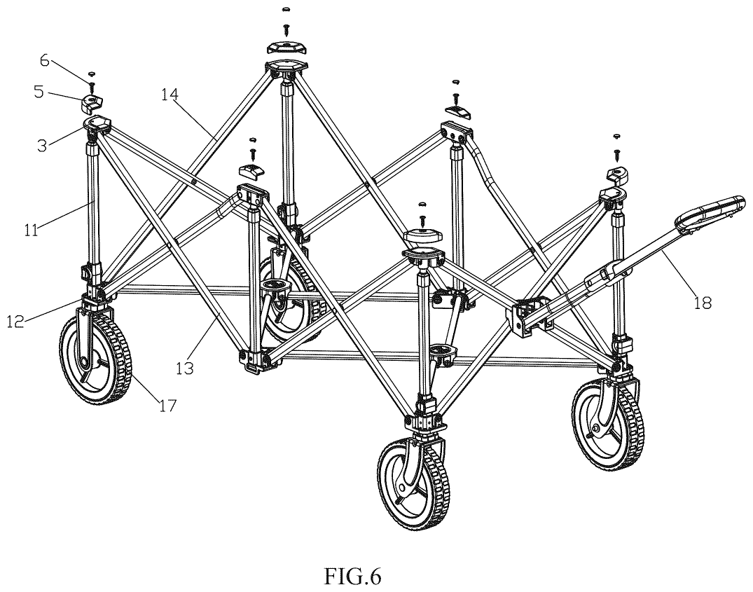

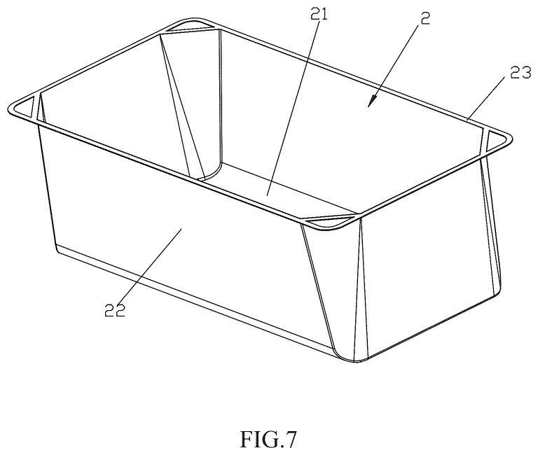

Referring to FIGS. 3 to 7, a pulling cart comprises a cart frame 1 and a flexible compartment 2. The cart frame 1 comprises two rows of columns 11 spaced apart in a left-and-right direction and two radial mechanisms. Each of the two rows of columns 11 comprises three columns 11 spaced apart in a front-and-rear direction. The three columns 11 are telescopic tubes. A top end of each of the three columns 11 is fixedly disposed with an upper connecting seat 3, and a bottom end of each of the three columns 11 is fixedly disposed with a lower connecting seat 12. A distance between the upper connecting seat 3 and the lower connecting seat 12 is changed according to telescopic movement of the telescopic tubes. A first scissor mechanism 13 is connected between the upper connecting seats 3 and the lower connecting seats 12 of each adjacent two columns 11 in each of the two rows of columns 11. Two second scissor mechanisms 14 are respectively connected between the upper connecting seats 3 and the lower connecting seats 12 of front columns 11 and rear front columns 11 on the two rows of the columns 11. The lower connecting seats 12 of the six columns 11 (i.e., each of the two rows of columns 11 comprises three columns 11) are arranged to form two adjacent rectangles, and each of the two adjacent rectangles is connected to a corresponding one of the two radial mechanisms. Each of the two radial mechanisms comprises a base 15 and four base rods 16. A first end of each of the four base rods 16 is rotatably connected to the base 15, and a second end of each of the four base rods 16 is rotatably connected to a corresponding one of four lower connecting seats 12 of the lower connecting seats 12 of the six columns 11 forming a corresponding one of the two adjacent rectangles. Rollers 17 are disposed below the cart frame 1. A front one of the two second scissor mechanisms 14 is disposed with a hand pull portion 18. The flexible compartment 2 comprises a bottom wall 21 and a peripheral wall 22 extending upward from an outer periphery of the bottom wall 21. An upper edge of the peripheral wall 22 extends outward to form a peripheral edge 23.

### Embodiment 1

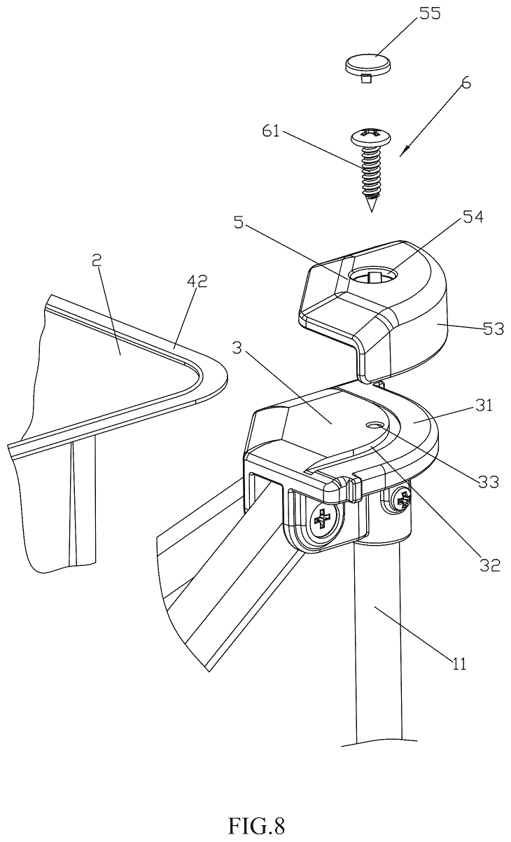

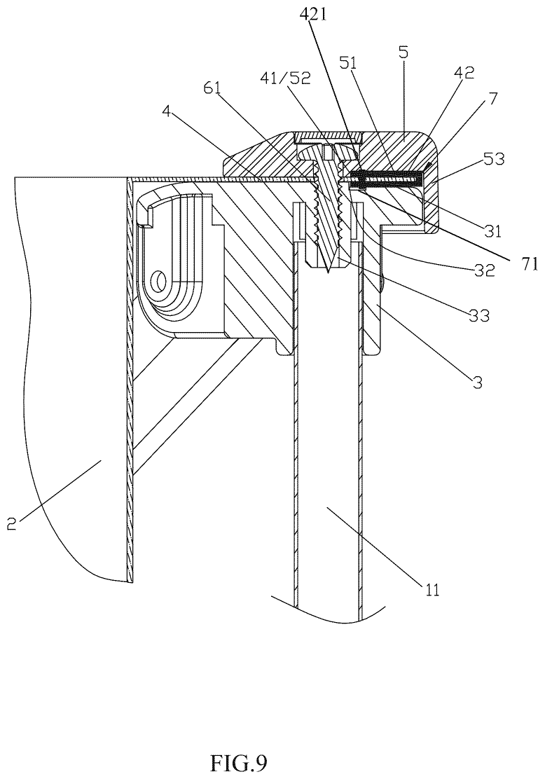

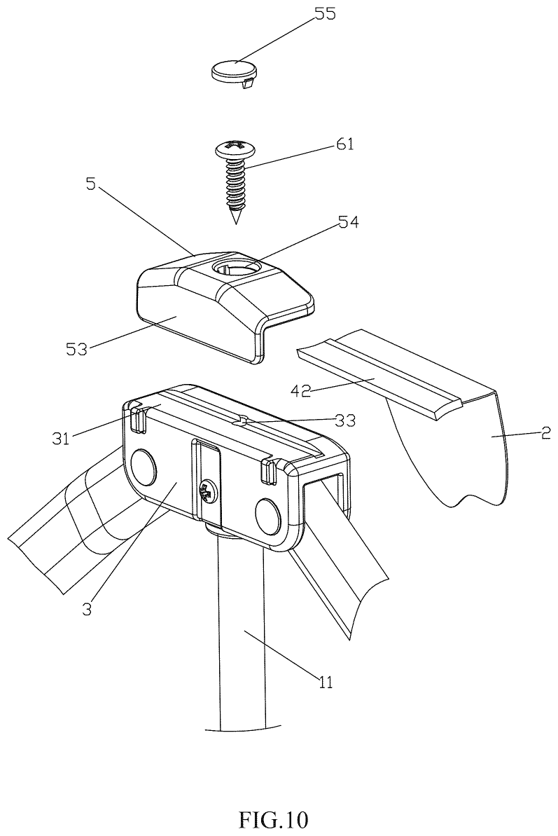

Referring to FIGS. 3 to 9, a connecting and fixing device between the cart frame 1 and the flexible compartment 2 of the pulling cart comprises the upper connecting seat 3, an edge portion 4, a pressing block 5, and a fixing structure 6.

The peripheral edge 23 of the flexible compartment 2 comprises the edge portion 4, and the edge portion 4 has a thickness difference structure and comprises a thicker portion (i.e., the edge portion has a first portion having a first thickness and a thicker portion having a second thickness greater than the first thickness) and an abutting portion 41 facing inward and formed by the thicker portion. In this embodiment, the thicker portion comprises an encasing edge 42 fixedly connected to the peripheral edge 23. The encasing edge 42 has two layers fixedly overlapping a top surface and a bottom surface of the edge portion 4, and inward-facing sides of the two layers form the abutting portion 41. For example, the encasing edge 42 is a sheet-like structure made of rubber material. The sheet-like structure is folded to fixedly surround the peripheral edge 23 to form the encasing edge 42, and the two layers of the sheet-like structure can be fixedly connected to the edge portion 4 by using fixing nails 421. As needed, the encasing edge 42 may only have a single layer, and the thicker portion may be directly formed by folding and sewing the peripheral edge 23. The edge portion 4 corresponds to the upper connecting seat 3, meaning the edge portion 4 is located on the upper connecting seat 3.

The pressing block 5 is disposed on the edge portion 4, and the fixing structure 6 enables the pressing block 5 and the upper connecting seat 3 to be fixedly connected together, causing the pressing block 5 and the upper connecting seat 3 to clamp the edge portion 4. A mating space 7 is formed between the pressing block 5 and the upper connecting seat 3. The thicker portion of the edge portion 4 is located within the mating space 7, and the abutting portion 41 can abut a limiting portion of the mating space 7 facing outward. First, the edge portion 4 is fixedly connected to the cart frame 1 and the flexible compartment 2 through “the pressing block 5 and the upper connecting seat 3 clamping the edge portion 4” and “the abutting portion 41 of the thicker portion abutting the limiting portion of the mating space 7” to achieve dual fixation through “clamping” and “abutting.” The edge portion 4 is clamped to ensure there is no space for the thicker portion to squeeze into at a clamping junction, thereby guaranteeing that the “abutting portion 41 always abuts the limiting portion”, resulting in secure fixation. Second, there is no need to create large holes or provide eyelet buckles on the edge portion 4, which enhances strength of the flexible compartment 2. A connection structure bears force evenly, has an aesthetically pleasing appearance, reduces the sewing workload in production, improves production efficiency, saves production costs, and generates economic benefits. Third, during processing, it may not be necessary to pre-punch holes in the flexible compartment 2 (for example, fasteners can directly pierce through the flexible compartment 2), which improves production efficiency, saves production costs, and generates economic benefits. Fourth, the thicker portion or the encasing edge 42 can strengthen the edge portion 4, preventing the thicker portion from tearing.

A top surface of the upper connecting seat 3 is recessed with a lower groove 31, and the lower groove 31 extends to an outer side surface of the upper connecting seat 3. The lower groove 31 has a first groove wall 32 facing outward, and a lower layer (i.e., of the two layer) of the encasing edge 42 is located within the lower groove 31. The bottom surface of the pressing block 5 is recessed with an upper groove 51, and the upper groove 51 has a second groove wall 52 facing outward. An upper layer (i.e., of the two layer) of the encasing edge 42 is located within the upper groove 51. The limiting portion comprises at least one of the first groove wall 32 or the second groove wall 52. The structure is simple, not only accommodating the thicker portion but also using the groove walls (i.e., the first groove wall 32 and the second groove wall 52) as the limiting portion. The structure is straightforward and easy to assemble. An outer side of the pressing block 5 extends downward to form an outer wrapping wall 53. The outer wrapping wall 53 is located outside the upper connecting seat 3 and at least encloses the upper groove 51 and the lower groove 31, resulting in an aesthetically pleasing appearance, preventing users from being pinched and injured, and offering high safety performance.

The fixing structure 6 comprises a fixing member 61. The pressing block 5 comprises an upper through hole 54, and the upper connecting seat 3 comprises a lower connecting hole 33. The fixing member 61 passes through the upper through hole 54 and is fixedly connected to the lower connecting hole 33 of the upper connecting seat 3, making the structure simple and assembly convenient. The fixing member 61 is located outside the mating space 7, enhancing the connection. A specific structure is described as follow. The fixing member 61 is a screw. The screw 61 passes through the pressing block 5 and the edge portion 4 from top to bottom and is screwed into the lower connecting hole 33 of the upper connecting seat 3 (as needed, the lower connecting hole 33 comprises internal threads, which can be directly set in the lower connecting hole 33 or a pre-embedded nut in the lower connecting hole 33). The screw can directly pierce through the edge portion 4 without the need for preparing a pre-made hole. The screw can be a self-tapping screw. The upper through hole 54 is a stepped hole, and a top of the upper through hole 54 is larger than a bottom of the upper through hole 54. A pressing lid 55 is additionally provided to cover the upper through hole 54 from top to bottom, enhancing aesthetics and safety. As needed, the fixing member 61 can be a bolt, and a nut is additionally provided. The fixing member 61 and the upper connecting seat 3 are assembled together by screwing the bolt and the nut.

The mating space 7 comprises a third groove 71 that cooperates with a distal end of the fixing nails 421 (i.e., enabling the two layers of the encasing edge 42 and the edge portion 4 to be fixedly connected together). For example, if this third groove 71 is located at a bottom of the lower groove 31, a fixed connection between the cart frame 1 and the flexible compartment 2 can be further strengthened through cooperation of the third groove 71 and the fixing nails 421.

In this embodiment, the upper connecting seat 3 is a corner upper connecting seat 3 located at a corner position of the cart frame 1.

### Embodiment 2

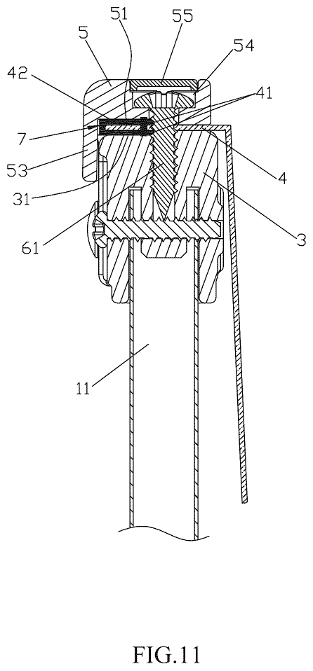

Referring to FIGS. 3 to 7, 10, and 11, the difference from Embodiment 1 is described as follow. The lower groove 31 extends to the lower connecting hole 33, and the upper groove 51 extends to the upper through hole 54. The abutting portion 41 of the edge portion 4 can abut the fixing member 61, ensuring a firm, stable, and reliable fixed connection. The upper connecting seat 3 is a middle upper connecting seat located at a middle position of the cart frame 1.

The above are only preferred embodiments of the present disclosure, and therefore should not be used to limit the scope of the present disclosure. That is, equivalent changes and modifications made based on the patent scope of the present disclosure and the content of the specification should still fall within the scope of the present disclosure.

What is claimed is:

1. A connecting and fixing device for a cart frame of a pulling cart and a flexible compartment, comprising:
an upper connecting seat,
an edge portion,
a pressing block, and
a fixing structure, wherein:
the cart frame comprises the upper connecting seat,
the flexible compartment has the edge portion,
the edge portion corresponds to the upper connecting seat and is disposed on the upper connecting seat,
the edge portion has a thicker portion and an abutting portion facing inward and formed by the thicker portion,
the pressing block comprises an upper through hole,
the fixing structure comprises a fixing member,
the pressing block is disposed on the edge portion,
the fixing member passes through the upper through hole of the pressing block and the edge portion to be connected to the upper connecting seat,
the fixing structure enables the pressing block and the upper connecting seat to be fixedly connected together, so that the edge portion is clamped by the pressing block and the upper connecting seat,
a mating space is formed between the pressing block and the upper connecting seat,
the thicker portion of the edge portion is located within the mating space, and
the abutting portion is configured to abut the fixing structure or a limiting portion of the mating space facing outward.

2. The connecting and fixing device for the cart frame of the pulling cart and the flexible compartment according to claim 1, wherein:
a top surface of the upper connecting seat is recessed with a lower groove,
the lower groove has a first groove wall facing outward,
at least a part of the thicker portion is located within the lower groove,
the limiting portion comprises the first groove wall, and
the abutting portion of the edge portion is configured to abut the limiting portion.

3. The connecting and fixing device for the cart frame of the pulling cart and the flexible compartment according to claim 2, wherein:
the lower groove extends to an outer side surface of the upper connecting seat,
an outer side of the pressing block extends downward to form an outer wrapping wall, and
the outer wrapping wall is located outside the upper connecting seat and at least encloses the lower groove.

4. The connecting and fixing device for the cart frame of the pulling cart and the flexible compartment according to claim 1, wherein:
a bottom surface of the pressing block is recessed with an upper groove,
the upper groove has a second groove wall facing outward,
at least a part of the thicker portion is located within the upper groove,
the limiting portion comprises the second groove wall, and
the abutting portion of the edge portion is configured to abut the limiting portion.

5. The connecting and fixing device for the cart frame of the pulling cart and the flexible compartment according to claim 1, wherein:
a top surface of the upper connecting seat is recessed with a lower groove,
the lower groove has a first groove wall facing outward,
a bottom surface of the pressing block is recessed with an upper groove,
the upper groove has a second groove wall facing outward,
the thicker portion is located within the upper groove and the lower groove,
the limiting portion comprises at least one of the first groove wall or the second groove wall, and
the abutting portion of the edge portion is configured to abut the limiting portion.

6. The connecting and fixing device for the cart frame of the pulling cart and the flexible compartment according to claim 1, wherein:
the upper connecting seat comprises a lower connecting hole,
the fixing member passes through the upper through hole and the edge portion and is fixedly connected to the lower connecting hole,
a top surface of the upper connecting seat is recessed with a lower groove,
the lower groove extends to the lower connecting hole,
at least a part of the thicker portion is located within the lower groove, and
the abutting portion of the edge portion is configured to abut the fixing member.

7. The connecting and fixing device for the cart frame of the pulling cart and the flexible compartment according to claim 1, wherein:
a bottom surface of the pressing block is recessed with an upper groove,
the upper groove extends to the upper through hole,
at least a part of the thicker portion is located within the upper groove, and
the abutting portion of the edge portion is configured to abut the fixing member.

8. The connecting and fixing device for the cart frame of the pulling cart and the flexible compartment according to claim 1, wherein:
the thicker portion comprises an encasing edge connected to a peripheral edge of the flexible compartment,
the encasing edge has at least one layer fixedly overlapping a surface of the edge portion, and
an inward-facing side of the at least one layer defines the abutting portion.

9. The connecting and fixing device for the cart frame of the pulling cart and the flexible compartment according to claim 8, wherein:
at least one fixing nail is provided to fixedly connect the edge portion and the at least one layer,
the mating space comprises a third groove that cooperates with a distal end of the at least one fixing nail,
the distal end of the at least one fixing nail is located within the third groove, and
the at least one layer of the encasing edge is two layers respectively fixedly overlapping a top surface and a bottom surface of the edge portion.

10. The connecting and fixing device for the cart frame of the pulling cart and the flexible compartment according to claim 1, wherein:
the fixing member is located outside the mating space.

11. The connecting and fixing device for the cart frame of the pulling cart and the flexible compartment according to claim 1, wherein:
the upper through hole is a stepped hole,
a top of the upper through hole is larger than a bottom of the upper through hole, and
a pressing lid is provided to cover the upper through hole from top to bottom.

12. The connecting and fixing device for the cart frame of the pulling cart and the flexible compartment according to claim 1, wherein:
the fixing member is a screw, and
the screw passes through the upper through hole of the pressing block and the edge portion from top to bottom and is screwed into the upper connecting seat.

13. A pulling cart, comprising: the connecting and fixing device for the cart frame of the pulling cart and the flexible compartment according to claim 1.
